(19) United States
(12) Patent Application Publication
(10) Pub. No.: US 2014/0140088 A1
(43) Pub. Date: May 22, 2014

(54) DEVICE AND PROCESS FOR THE GENERATION OF DYNAMIC LIGHT EFFECTS

(71) Applicant: Hella KGaA Hueck & Co., Lippstadt (DE)

(72) Inventor: Jürgen Griebel, Maulburg (DE)

(21) Appl. No.: 14/076,995

(22) Filed: Nov. 11, 2013

(30) Foreign Application Priority Data
Nov. 13, 2012 (DE) 102012220696.5

(51) Int. Cl. F21V 8/00

(52) U.S. Cl. CPC G02B 6/0005
USPC 362/555; 362/583

(57) ABSTRACT

A device for creating dynamic light effects includes an optical fiber with at least two light sources (, which feed light into the optical fiber, wherein the light from the light sources is mixed in the optical fiber in such a manner that a variation of color is identifiable in the optical fiber, and wherein the light sources can be controlled in such a manner that a dynamically changing color distribution is obtained in the optical fiber. A related process is also disclosed.

### CROSS REFERENCE

This application claims priority to German Patent Application No. 10 2012 220696.5, filed Nov. 13, 2012.

### TECHNICAL FIELD OF THE INVENTION

The invention relates to a device and a process for the generation of dynamic light effects.

### BACKGROUND OF THE INVENTION

Light effects are used in automobiles so that lighting functions or displays or warning functions are noticed. Thus static light effects are well known. Alternating light effects are also known, wherein light sources are switched on and off.

Moreover, dynamic light effects are known, wherein several light sources are arranged in a chain that are switched on or off one after another in order to create a running band of light. In this respect, however, depending on the length of the band of light, a large number of light sources are provided that need to be individually controlled. These devices with a large number of light sources are associated with correspondingly high costs.

### SUMMARY OF THE INVENTION

Hence, the object of the present invention is a device and a process for creating dynamic light effects that can be implemented at a favorable cost.

An exemplary embodiment of the invention concerns a device for creating dynamic light effects using an optical fiber with at least two light sources that feed light into the optical fiber, wherein the light from the light sources is mixed in the optical fiber in such a manner that a color variation is identifiable in the optical fiber, and wherein the light sources can be controlled in such a manner that a dynamically changing color distribution in the optical fiber results. By mixing the light and controlling its time-related changes, the optical fiber can be seen as a dynamically changing colored optical fiber. In contrast to the prior art, the dynamic light effect is not caused by switching light sources on and off, but by the dynamic mixing of light. Since this can be achieved with few light sources, it is correspondingly cost effectively to achieve.

In this respect, it is expedient if the optical fiber comprises at least one linear optical fiber or at least one flat optical fiber or an arrangement of linear and/or flat optical fibers. In this manner it is possible to achieve a linear or a flat structure or a mixture of different linear and/or flat structures in order to obtain a desired optical light effect. For example, in the case of an arrangement of a plurality of linear optical fibers, the light sources can also be controlled in such a manner that there is a transition of a dynamic light effect from one optical fiber to another optical fiber.

It is also expedient if, when using a linear optical fiber, the light from at least one light source can be fed into the optical fiber at each end of the optical fiber. In this way, a dynamic mixing of light can be produced along the path of the linear optical fiber that is fed at the two ends and thus a linear light variation and linear light movement of the mixed light can be achieved.

It is also expedient if another light source is provided, which feeds light into the optical fiber wherein this light is fed in between the two light sources at the ends or this light is fed into the optical fiber at a distance from the other light sources. In this manner another effect can be obtained, since the light from three light sources can then be mixed in order to obtain a dynamic effect.

It is also expedient if the light source is coupled directly to the optical fiber in order to feed the light into the optical fiber or that the light source is coupled to the optical fiber by means of a transfer optical fiber in order to feed the light into the optical fiber. As a result, the design of the optical fiber can be selected independently of the choice of the light source and its fixing.

It is also expedient if the light source is an LED, wherein the LED is formed as a common LED with multiple colors within one LED housing, or the LED is formed as a single-color LED with only one color. In this way, a high level of light intensity can be obtained in a small space for feeding light into the optical fiber.

It is expedient if the common LED is an RGB LED with the colors red, green and blue, or alternatively, if it is an LED that emits white light and light of other colors. In this way, the LED with white light may comprise such a diode wherein other colors could be available. As an RGB LED, red light is emitted from one LED, blue light from another LED and green light from yet another LED. Alternatively, the RGB LED may also comprise another LED with light of a different color, such as white light, for example.

It is also advantageous if the optical fiber is integrated into a headlight, a tail light, a flasher, a display instrument or a control element. Alternatively, the optical fiber may also emerge in an optical element, aperture element or decorative element in order to illuminate the same. Accordingly, the function of the dynamic light effects may be used in various areas of application, particularly in a vehicle.

An exemplary embodiment relates to a process for creating dynamic light effects by means of an optical fiber with at least two light sources, wherein the light sources feed light into the optical fiber and the light of the light sources is mixed in the optical fiber in such a manner that a color pattern can be seen in the optical fiber, and wherein the light sources can be controlled in such a manner that a dynamically changing color distribution is obtained in the optical fiber.

In this respect, it is advantageous if the optical fibers comprise at least one linear optical fiber or an arrangement of linear and/or flat optical fibers and the light of at least two light sources is controlled with respect to the color and/or intensity in such a manner that a dynamic light effect is created by the mixed light.

It is also expedient if light of varying color is fed in by means of at least two light sources and the light intensity and/or color of at least one of the at least two light sources, or especially of the at least two light sources, is controlled to create a dynamic light effect. In this way, the respective control of a mixture of the light can take place that produces a locally resolved dynamic mixture.

It is also expedient if, by means of two light sources, light of varying color is fed in and the lighting intensity of a first light source is reduced or increased and/or the light intensity of a second light source is increased or reduced to create a dynamic light effect. Alternatively, only one light source may be controlled accordingly such that the light intensity changes, such as by being increased or reduced, and the other light source can maintain its light-intensity setting.

It is also expedient if, by means of two light sources, light of varying color is fed in and the light intensity of a first light source is reduced or increased and the light intensity of a second light source is kept essentially constant to create a dynamic light effect.

It is also expedient if the color of the first and/or the second light source is additionally or alternatively controlled in a variable manner. By doing so, dynamic light effects with changing color patterns can be generated.

In this respect, with one exemplary embodiment of the invention it is advantageous if two optical fibers are provided, each comprising one light feed by means of a light source at the end, wherein one end of an optical fiber is arranged adjacent to one end of the other optical fiber and wherein the light sources are controlled in such a manner that the dynamic light effect passes from one optical fiber to the other.

It is also advantageous if the light source or light sources can be switched on or off completely in order to achieve additional light effects.

Moreover, it is expedient if a further light source is provided, which feeds light into the optical fiber, wherein this light is fed in between the two end-side light sources or this light is fed into the optical fiber at a distance from the other light sources, wherein this additional light source is controlled in such a manner that the light emitted has a dynamic or static variation of intensity and/or color with time.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 a schematic representation of a device according to the invention for the generation of dynamic light effects,

FIG. 2 a schematic representation of the device according to FIG. 1,

FIG. 3 a schematic representation of a device according to the invention for the generation of dynamic light effects,

FIG. 4 a schematic representation of a device according to the invention for the generation of dynamic light effects,

FIG. 5 a schematic representation of a device according to the invention for the generation of dynamic light effects,

FIG. 6 a schematic representation of a device according to the invention for the generation of dynamic light effects,

FIG. 7 a schematic representation of a device according to the invention for the generation of dynamic light effects,

FIG. 8 a schematic representation of a device according to the invention for the generation of dynamic light effects,

FIG. 9 a schematic representation of a device according to the invention for the generation of dynamic light effects, and

FIG. 10 a schematic representation of a device according to the invention for the generation of dynamic light effects.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

The invention relates to a device and a process for the generation of dynamic light effects. The exemplary embodiments of the figures have characteristics wherein the characteristics of various exemplary embodiments can be combined with one another.

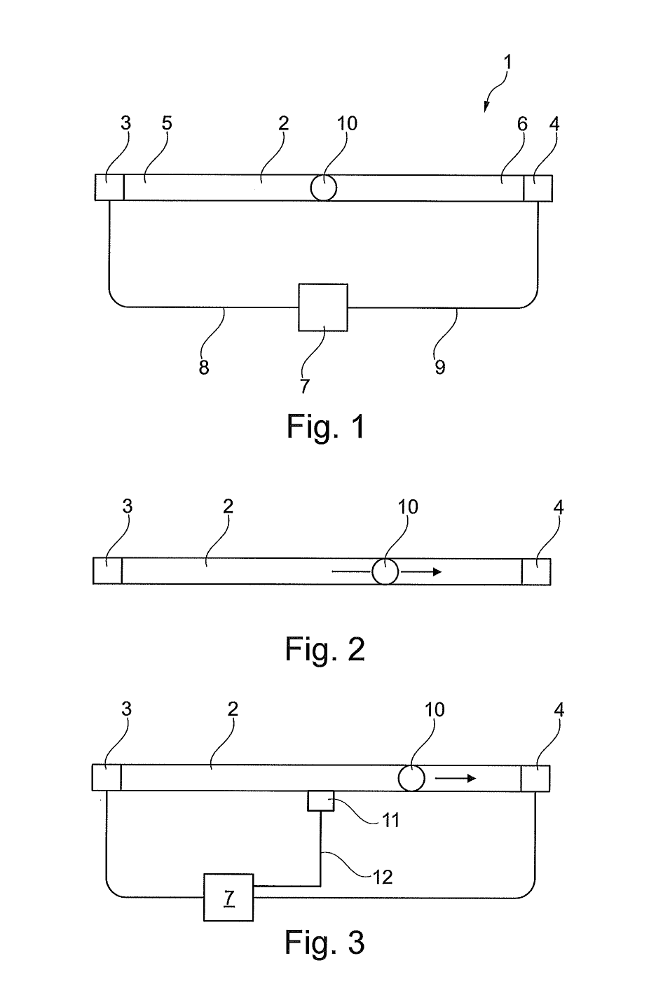

FIG. 1 illustrates a device 1 for the generation of dynamic light effects with an optical fiber 2 having at least two light sources 3 and 4. The light sources 3 and 4 are arranged on the linear shaped optical fiber 2 at the end faces 5 and 6. The light sources 3 and 4 are controlled by a control unit 7, wherein the control unit 7 is electrically connected to light sources 3 and 4 via connecting leads 8 and 9. Depending on the design of the exemplary embodiment, the control unit 7 can control the intensity and/or the color of the light emitted by the light sources 3 and 4.

FIG. 1 illustrates the arrangement of a linear optical fiber 2, which, in the exemplary embodiment of FIG. 1 is fitted with one single-color LED each as the light sources 3 and 4 at each end face 5 and 6. The color, as in the light color, of the two light sources 3 and 4 is different. Thus, for example, the color of light source 3 is red and the color of light source 4 is green. The color of the light from one light source 3, 4 is visible in the optical fiber 2 and reduces in intensity starting from the end face 5 and 6, where light sources 3 and 4 are arranged, to the opposite end faces 6 and 5. For the other light source 4, the inverse is the case, so that the light emitted by these light sources 4 and 3 is also visible in the optical fiber 2 and reduces in intensity from the end faces 6 and 5, at which the light source 4 is arranged with respect to the opposite ends 5 and 6.

Where the intensity of both light colors is identical, the mixed color is obtained, and with the example of the two colors red and green, the mixed color yellow would be obtained. This zone of mixed color is marked as area 10 in the Figure. Between the area 10, where the light intensity of both colors is the same, and the two end faces 5 and 6, the mixed color transitions to the color of the respective light source 3 or 4. In the exemplary embodiment of FIG. 1, the color changes from yellow through orange to red and from yellow through green-yellow to green.

By dynamically varying the intensity of one of the light sources 3, 4 or even both light sources 3 and 4 simultaneously, the location in the optical fiber at which the intensity of the light of both colors is identical gets shifted. As a result, there is a movement of the location of the mixed color and thus the locations or sections where the color transitions from the mixed color to the respective pure colors of the light emitted by light sources 3 and 4. Since the location of the mixed color, as in area 10, changes due to the variation of the light intensity of the two initial colors, the effect of a moving light color is created.

FIG. 2 illustrates how the area 10, i.e., the area of the mixed color, starts at the central position in FIG. 1 and moves to the right towards the light source 4.

In another exemplary embodiment, the light sources 3, 4 at the respective end faces 5 and 6 of the optical fiber 2 can emit not only one color but, for example, two colors each at the two ends of the optical fiber. This creates the option of not only controlling the intensity of the light emitted by the light sources, but also that the color at the ends can be varied. If the two light sources 3 and 4 at the end faces of the optical fiber 2 are identical, then, for example, the colors at the ends can be interchanged, which means that with a red-green LED as the light source, the transition from red to green can take place from the right to the left, wherein the area of the mixed color shifts up to one end, then, for example, the light colors can be interchanged in order to cause a shifting process in the opposite direction.

In the embodiment of FIG. 3, in addition to the light sources 3 and 4 arranged respectively at the end face of the optical fiber 2, there is a further light source 11, which is arranged approximately at the middle of optical fiber 2 and feeds its light into the optical fiber at that point. In this case, light source 11 is furthermore controlled by the electronic control unit 7 via lead 12. By adding a further light source 11, for example an LED, a greater variety in the creation of dynamic light effects can be achieved, since there can be much more variation in the mixture of light along the length of optical fiber 2, since the point of equal light intensity is now determined by three light sources 3, 4 and 11, and thus a greater variety is possible.

Moreover, by briefly switching on and off or reducing the intensity of the third light source 11, jumping or very fast movement of the points of equal light intensity in the areas 10 can be produced.

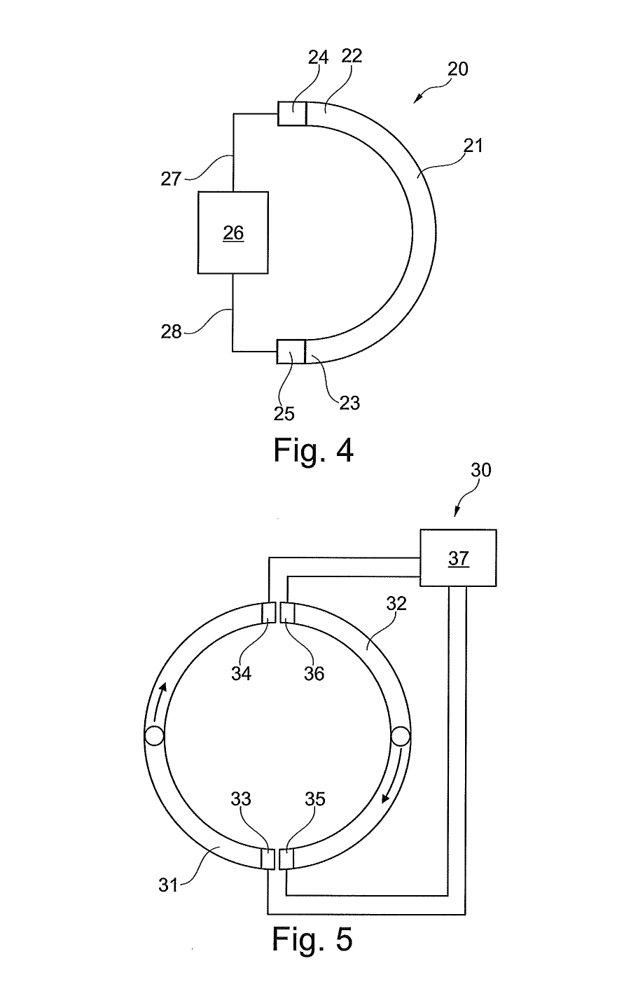

FIG. 4 illustrates another exemplary embodiment of a device 20 for the generation of dynamic light effects, wherein the optical fiber 21 takes on an arcuate, advantageously semicircular shape. Alternatively, the arc can be extended further so that it becomes U-shaped or appears like a parabola when placed on its side.

Moreover, the optical fiber 21 has end faces 22 and 23 at which the light sources 24 and 25 are arranged, and these feed light into the optical fiber. The light sources 24 and 25 are controlled by means of the control unit 26, wherein the light sources are connected to the control unit 26 by means of leads 27 and 28.

By designing the optical fiber 21 to be a linear optical fiber, a plurality of designs can be implemented in order to create a dynamic light effect in one embodiment. Accordingly, the design of the optical fiber 21 is possible in several shapes, wherein the exemplary embodiments illustrated in FIGS. 1 to 4 do not imply any restriction on the scope of the patent protection.

FIG. 5 illustrates an arrangement of two semicircular optical fibers 31 and 32 in a device 30 for creating dynamic light effects. The optical fibers 31 and 32 are fed with light by means of the light sources 33 and 34, and 35 and 36, respectively, wherein the light sources 33 to 36 are controlled by control unit 37. By arranging two semicircular optical fibers 31 and 32 as a circle, the light color can also move in a circle from one optical fiber 31, 32 to the next optical fiber 32, 31 under the appropriate control.

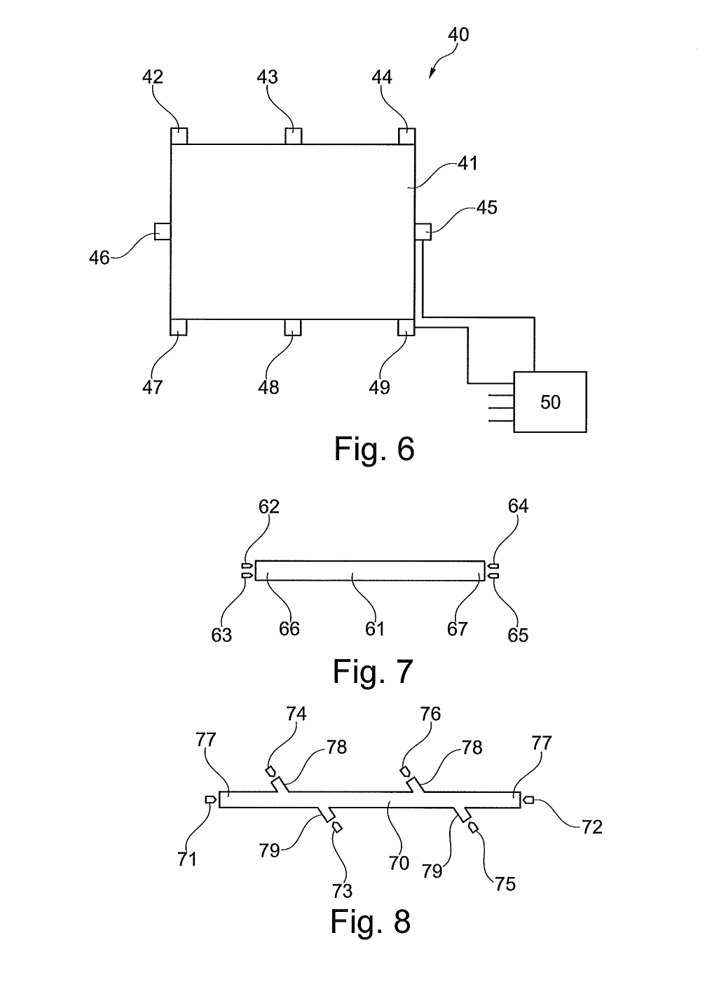

FIG. 6 illustrates a further embodiment of a device 40 for creating dynamic light effects, wherein a flat optical fiber 41 is provided, with an arrangement of light sources 42 to 49, wherein a control unit 50 is provided to control the light sources 42, 49 respectively.

By arranging the light sources 42 to 49 and by controlling them, a dynamic light effect with respect to the mixed colors can be obtained on the surface of the flat optical fiber 41.

With the exemplary embodiments it is particularly advantageous if an LED is used as the light source. In this case, an LED that emits only one light color can be used, i.e., it emits light of a specific color. Alternatively, an LED can be used that can emit multiple light colors, i.e., it can emit light of several colors. For example, an RGB LED can be used, which comprises three LEDs for the generation of red, green and blue light within a single housing. As an alternative to this, three separate LEDs can be used that emit red, green or blue light accordingly. As a further alternative, an LED can be used that additionally emits light of another color, such as, for example, white light or another light color.

With the combined LEDs, individual LEDs may be accommodated in one LED housing or the individual LEDs may be combined without any constructional unit or even a combination of these options may be used.

The light sources, such as LEDs in particular, can be connected directly to the optical fiber in order to be able to feed the light emitted by the light source directly into the optical fiber. For this purpose, the light source can be connected to the optical fiber in a form-fit or firmly bonded manner, so that the light source becomes structurally unified with the optical fiber. Alternatively, the light source may be arranged, for example, on a circuit board, and the light from the light source can be transferred to the actual optical fiber by means of a transfer optical fiber.

Apart from the example listed above of the mixing of two colors of light, there is also the option of mixing white light with the colored light. For this purpose, in a manner similar to that illustrated in FIG. 1, one light source is provided that emits white light and another light source is provided that emits colored light, such as, for example, red light or green light or violet light. If at first only the white light is switched on, then the optical fiber is colored white by the white light, and if colored light is then gradually faded in, then the perception is not of a color transition, as in the case of the example with the red and green light in FIG. 1, but instead of an effect of a varyingly intense color saturation along the length of the optical fiber. The appearance is of a transition from red through dark and light pink right up to white.

The effect generated as a result is that the color becomes increasingly pale from the side of the colored light source to the side of the white light source, with its color saturation diminishing from a saturated color shade right through to white. This effect can also be referred to as a comet's tail. It may also be advantageous to intensify this light effect by controlling the light source not only with respect to its intensity but also by controlling the color to create a dynamic effect. In this case, the color can either be switched, or the color may be changed continuously. This continuous change can be accompanied by a variation in the light intensity, for example. This produces a light effect that resembles a moving comet. This effect can also be described by saying that the optical fiber appears to be filled with color like a glass full of water into which a colored liquid is poured.

This effect is achieved by replacing the light source at one end of the optical fiber according to FIG. 1 with a white LED, and by arranging one or more colored LEDs as light sources at the other end. In this case, the effect referred to can proceed only in one direction. If, for example, the white light color is generated by means of an RGB LED placed on both sides of the optical fiber, then the effect can be displayed in both directions, since white light can also be generated by means of the RGB LED by mixing the three primary colors, while colored light can be emitted on the other side. If, for example, the optical fiber is completely saturated with red by starting out with a white optical fiber resulting from feeding in white light and initially feeding in red light, then the process can be dynamically reversed by feeding in white light.

The exemplary embodiment cited in relation to red light can also, of course, be controlled for all other light colors.

As an application of the dynamic light effects and the corresponding devices in an automobile, for example, there are several options available. Thus, an appropriate optical fiber can be placed in the tail light of an automobile, for example, wherein the optical fiber is aligned transversely to the direction of travel, such that an LED is placed as a light source on the outside of the vehicle, for example, and another LED is provided as a light source at the inner end of the optical fiber. If the LEDs at the edge or outside of the vehicle are white LEDs, and if the light sources arranged at the middle of the vehicle are orange or red LEDs, then the intensity of a band of orange or red light in the optical fiber can be faded up from the center of the vehicle to its edge. This effect can be further enhanced by simultaneously fading down the intensity of the white light, so that the colored light appears to move from the central area of the vehicle to the outside of the vehicle. The same may be applied, for example, in a vehicle headlight, so that in the case of an optical fiber being installed above the headlamp, a “flashing” effect can be achieved if a white optical fiber is filled with a colored light according to the process described above. In this case, by using an orange-colored light, the “filling up” of the white optical fiber can also be used as an indicator light if the frequency of filling-up effect is set according to the approved indicator frequency.

Moreover, it is perfectly possible that the illumination of optical fiber can be increased and decreased by switching the light sources on and off or by changing the light intensity, but without changing the color sequence.

It is also advantageous if the light sources are controlled by means of PWM frequencies for light sources at opposing ends, such as LEDs, wherein, for example, a variation of the frequencies of the PWM frequencies can be used.

The optical fibers can be designed in such a manner that by means of their shape or their cross sections and by means of additional optical elements on the optical fiber, advantageous effects can produced, resulting in curved regions of the optical fiber being completely illuminated, for example. For this purpose, optical elements such as, for example, prisms or lenses or rough surfaces can be provided, which promote reflection of the light within the optical fiber even in zones that would have been illuminated less brightly without these additional elements.

The use of flat optical fibers may also be provided in vehicle interiors, for example, even inside the vehicle, to produce a surface light effect behind decorative elements or decorative surfaces that includes the dynamic light effects.

In this case, according to FIG. 6, a plurality of light sources can be placed on one side of a flat optical fiber or on many sides or around the flat optical fiber, wherein light sources such as LEDs, for example, may furthermore be placed on or behind the surface of the flat optical fiber. By a time-dependent variation of the intensity of the light sources, a surface light sequence can be created that, for example, can resemble a flickering fireplace, wherein the variation of the light intensity over the surface can be controlled in a regular, irregular or random manner.

By an appropriate arrangement, the mixed color can be produced in a circular pattern instead of a linear one, so that the circular patterns of mixed color move dynamically, for example, from inside to outside or from outside to inside. For example, a yellow point can turn into a yellow circle and even into a yellow surface, so that a dynamic change in the illumination of the flat optical fiber can be controlled.

Moreover, the creation of dynamic light effects can also be used for display devices, in a vehicle, for example, if status indications need to be displayed with these devices. Thus, for example, a distance indicator can be displayed optically as a distance warning device, so that, for example, the distance of a vehicle from an obstacle or from another vehicle can be displayed by the device, wherein on the vehicle approaching the obstacle the optical fiber changes color depending on the proximity. A vehicle in the adjacent lane can also be indicated by means of such a status display. Moreover, such devices can also be applied to create dynamic light effects as status indications in an automobile. Thus, for example, the positions of windows or sunroofs can be displayed. Alternatively, they can also be used to display other indications, for example, the distribution of the volume setting of an audio system, also known as the balance, wherein the distribution from left to right or from front to back can be displayed.

Moreover, a temperature can be displayed, the temperature inside a vehicle, for example, for which the optical fiber is colored according to the temperature. With change in the temperature, the colors can also be shifted according to the rising temperature. Alternatively, the opening angle of a door or the level of a tank or a water container, such as for the windshield washer, can be displayed.

Dynamic operations such as the acceleration of the vehicle can also be displayed by means of a suitable display device with an optical fiber that changes its color.

The provision of an optical fiber according to the invention with a device for creating dynamic light effects would have the advantage that, for example, in a warning device for the proximity of the vehicle to an obstacle, the displays do not need to be permanently assigned to a circuit board, by, for example, having LEDs with appropriate colors permanently fixed to the board. By sophisticated color mixing of the light in the optical fiber, a large number of different colored states and dynamic states of the light can be produced with a few LEDs.

In this way, for example, the same display device can also be used with a device for creating dynamic light effects, wherein a change can be made in the display for the right side or for the left side without having to change the device itself. In this case it may be sufficient for the light colors to be controlled accordingly to produce a display for the right or left side of the vehicle, which, for example, is advantageous for a distance warning indicator with optical support.

Furthermore, it can be expedient if, in conjunction with the control of the color or the light intensity, a sensor is provided with the optical fiber, which may be placed in front of, inside or behind the optical fiber. In this manner, it can be controlled such that the position of a finger touching the optical fiber, for example, can be tracked with respect to the color control, if this finger is shifted over the optical fiber. In this way, operating concepts, such as are known from so-called touch-screen displays, can also be incorporated and displayed accordingly, such as sliding, zooming or single and double clicking of display elements.

FIG. 7 illustrates an alternative arrangement of a linear optical fiber 61, which, in the exemplary embodiment of FIG. 7, is fitted at both ends with two single- or multi-colored LEDs fitted as the light sources 62, 63, 64 and 65 on each of the respective end faces, 66 and 67. Since two LEDs are placed one over another as the light sources, multi-colored effects can be obtained. A multiple arrangement of light sources instead of only one light source at one feed point of the light can also be used in other exemplary embodiments.

FIG. 8 illustrates an alternative arrangement of a linear optical fiber 70 to the optical fiber of FIG. 3. In FIG. 8 there is an arrangement of multiple light sources 71, 72, 73, 74 and 75 , wherein the two light sources 71 and 72 are placed at each of the end faces 77 of the optical fiber. Light sources 73 to 75 are placed in the middle region of the optical fiber and feed their light into the optical fiber at a non-perpendicular angle. For this purpose, the optical fiber has an entry each, 78 and 79, that is aligned at an angle not equal to 90° to the longitudinal stretch of the optical fiber. The entries 78 and 79 are also aligned towards both sides of the optical fiber.

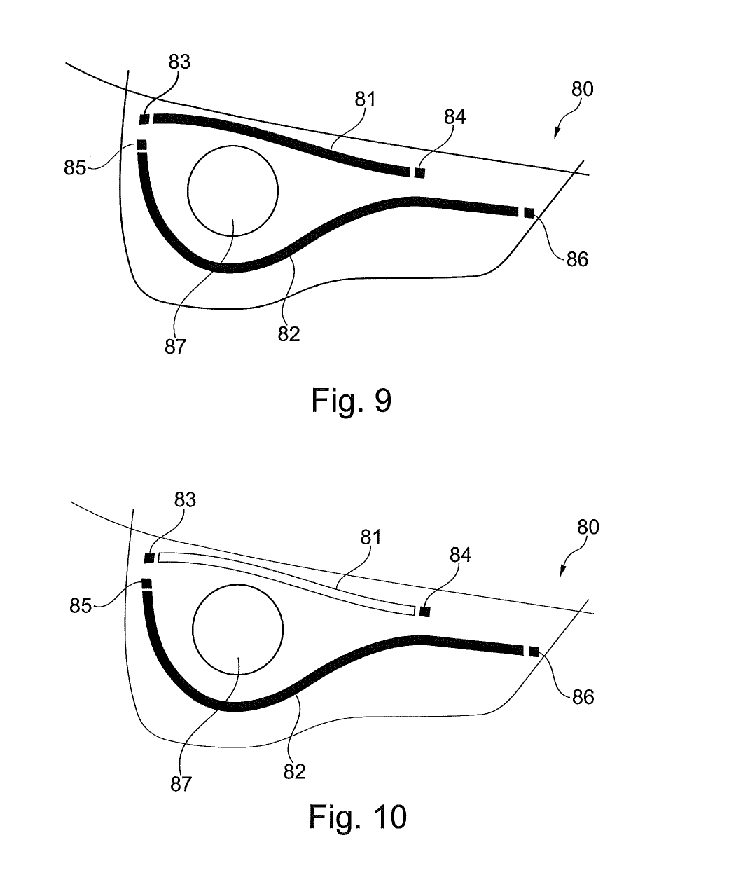

FIGS. 9 and 10 each illustrate a contour of a headlight 80, in which two optical fibers 81 and 82 are arranged. The optical fibers 81 and 82 are each supplied with light by means of two light sources 83 and 84, and 85 and 86, such as LEDs, which feed their light into the end face of the respective optical fibers 81 and 82.

Using the control process according to the invention, the upper and/or lower optical fiber 81, 82 can be controlled for dynamic color change so that a kind of “flashing” is seen. In FIG. 9, both the optical fibers 81 and 82 light up, whereas in FIG. 10 only the lower optical fiber lights up. In the case of an optical fiber 81 being installed above the headlamp 87, a “flashing” effect can be achieved if a white optical fiber is filled with a colored light according to the process described above. In this case, by using an orange-colored light, the “filling up” of the white optical fiber can also be used as an indicator light.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCE SIGNS

1 Device
2 Optical fiber
3 Lamp
4 Lamp
5 Front-side end
6 Front-side end
7 Control unit
8 Lead
9 Lead
10 Range
11 Lamp
12 Lead
20 Device
21 Optical fiber
22 Front-side end
23 Front-side end
24 Lamp
25 Lamp
26 Control unit
27 Lead
28 Lead
30 Device
31 Optical fiber
32 Optical fiber
33 Lamp
34 Lamp
35 Lamp
36 Lamp
37 Control unit
40 Device
41 Lamp
42 Lamp
43 Lamp
44 Lamp
45 Lamp
46 Lamp
47 Lamp
48 Lamp
49 Lamp
50 Control unit
61 Optical fiber
62 Lamp
63 Lamp
64 Lamp
65 Lamp
66 Front-side end
67 Front-side end
70 Optical fiber
71 Lamp
72 Lamp
73 Lamp
74 Lamp
75 Lamp
76 Lamp
77 Front-side end
78 Entry
79 Entry
80 Headlight contour
81 Optical fiber
82 Optical fiber
83 Lamp
84 Lamp
85 Lamp
86 Lamp
87 Headlight light source

1. A device for creating dynamic light effects, comprising:
an optical fiber with at least two light sources, which feed light into the optical fiber,
wherein the light from the light sources is mixed in the optical fiber to produce a color pattern that is identifiable in the optical fiber and
wherein the light sources are operable to produce a dynamically changing color distribution in the optical fiber.

2. The device according to claim 1, wherein the optical fiber comprises at least one of a linear optical fiber, a flat optical fiber, or an arrangement of linear and flat optical fibers.

3. A The device according to claim 1, 2, wherein when at each end of the linear optical fiber, light from at least one light source can be fed into the optical fiber.

4. The device according to claim 1, further comprising a further light source which feeds light into the optical fiber, wherein this light is fed in between the two light sources at the ends or at a distance from the other light sources.

5. A device according to at least one of the previous claims, characterized in that the light source is coupled directly to the optical fiber in order to feed the light into the optical fiber, or in that the light source is coupled with the optical fiber by means of a transfer optical fiber in order to feed the light into the optical fiber.

6. The device according to claim 1, wherein the light source is an LED, wherein the LED is takes the form of either a combined LED with multiple colors in one LED housing or a single-color LED with only one color.

7. The device according to claim 6, wherein the combined LED is one of an RGB LED with the colors red, green and blue or an LED that emits white light and light of at least one other color.

8. The device according to claim 1, wherein the optical fiber is integrated into one of a headlight, a tail light, a flasher, a display instrument or a control element.

9. A process for creating dynamic light effects with an optical fiber having at least two light sources, wherein the light sources feed light into the optical fiber, and the light from the light sources is mixed in the optical fiber to produce a color pattern that is identifiable in the optical fiber, and wherein the light sources are operable to produce a dynamically changing color distribution in the optical fiber.

10. The process according to claim 9, wherein the optical fiber comprises at least one of a linear optical fiber, a flat optical fiber, or an arrangement of linear and flat optical fibers and the light of the two light sources that are controlled with respect to at least one of their color or intensity to produce a dynamic light effect is created by the mixed light.

11. The process according to claim 9, characterized in wherein, light of different colors from the two light sources is fed in and at least one of the intensity or color of at least one of the two light sources is controlled to create a dynamic light effect.

12. The process according to claim 11, wherein light of different color from the two light sources is fed in and the intensity of at least one of the light sources is reduced or increased to create a dynamic light effect.

13. The process according to claim 11, wherein light of different color from at least one of the two light sources is fed in and the intensity of one of the two light source is reduced or increased to create a dynamic light effect.

14. A process according to claim 12, wherein the color of at least one of the two light sources is varied.

15. The process according to claim 9, wherein two optical fibers are provided, each having an input of light from light sources, wherein one end of the first optical fiber is arranged adjacent to one end of the other optical fiber and wherein the light sources are operable to pass a dynamic light effect from one optical fiber to the other.

16. The process according to claim 9, wherein one or both light sources are operable to be switched completely on or off to achieve additional light effects.

17. The process according to claim 9, wherein a further light source is provided which feeds light into the optical fiber, wherein this light is fed in between the two end-side light sources or at a distance from the other light sources, wherein this additional light source is operable to emit a light having a dynamic or static variation of intensity or color with time.

18. The process according to claim 13, wherein the color of at least one of the two light sources is varied.

19. The process according to claim 13, wherein the intensity of the other light source is maintained substantially constant.
